(19) United States
(12) Patent Application Publication
(10) Pub. No.: US 2024/0413548 A1
(43) Pub. Date: Dec. 12, 2024

(54) ELECTRIC CONNECTOR AND METHOD FOR MANUFACTURING ELECTRIC CONNECTOR

(71) Applicant: SUMITOMO ELECTRIC INDUSTRIES, LTD., OSAKA (JP)

(72) Inventor: Yasunori ASANO, Osaka-shi (JP)

(73) Assignee: SUMITOMO ELECTRIC INDUSTRIES, LTD., OSAKA (JP)

(21) Appl. No.: 18/731,892

(22) Filed: Jun. 3, 2024

(30) Foreign Application Priority Data
Jun. 7, 2023 (JP) 2023-093962

(51) Int. Cl. H01R 9/24; H01R 43/20

(52) U.S. Cl. CPC H01R 9/2416; H01R 43/20

(57) ABSTRACT

An electric connector includes a plurality of first electric wires each extending along a first direction and arranged side by side, and a housing including a plurality of first holding holes each extending and penetrating along the first direction and arranged side by side. A conductor of a tip portion of each of the plurality of first electric wires is housed in each of the plurality of first holding holes. The plurality of first holding holes hold the plurality of first electric wires such that the tips of the plurality of first electric wires are exposed on the front surface of the housing. The housing is provided with a first guide portion configured to, while supporting the plurality of first electric wires, introduce each of the plurality of first electric wires into each of the plurality of first holding holes toward the front surface of the housing.

### TECHNICAL FIELD

The present disclosure relates to an electric connector and a method for manufacturing an electric connector. The present application claims priority based on Japanese Patent Application No. 2023-093962 filed on Jun. 7, 2023, the entire contents of which are incorporated herein by reference.

### BACKGROUND

JP2017-069166A discloses an example of an electric connector capable of connecting to the mating electric connector. In this electric connector, each of a plurality of conductive wires is inserted into and fixed to each through hole provided in a housing.

### SUMMARY

An electric connector according to the present disclosure includes a plurality of first electric wires each extending along a first direction and arranged side by side along a second direction intersecting the first direction, and a housing including a plurality of first holding holes each extending and penetrating along the first direction and arranged side by side along the second direction. A conductor of a tip portion of each of the plurality of first electric wires is housed in each of the plurality of first holding holes. The plurality of first holding holes hold the plurality of first electric wires such that the tips of the plurality of first electric wires are exposed on the front surface of the housing. The housing is provided with a first guide portion configured to, while supporting the plurality of first electric wires, introduce each of the plurality of first electric wires into each of the plurality of first holding holes toward the front surface of the housing.

### BRIEF DESCRIPTION OF THE DRAWINGS

FIG. 1 is a front view of an electric connector according to a first embodiment as viewed from the front;

FIG. 2 is a cross-sectional view of the electric connector shown in FIG. 1 taken along line II-II;

FIG. 3 is a perspective view of the electric connector shown in FIG. 1 as viewed from the front, in which some of the electric wires are omitted;

FIG. 4 is a perspective view of the electric connector shown in FIG. 1 as viewed from the rear, in which some of the electric wires are omitted;

FIG. 5 is an enlarged perspective view showing a state where electric wires are placed in grooves of a guide portion of the electric connector shown in FIG. 1;

FIG. 6 is a perspective view of an electric connector according to a second embodiment as viewed from the rear, in which some of the electric wires are omitted;

FIG. 7A is a diagram for describing a method for manufacturing the electric connector shown in FIG. 6;

FIG. 7B is a diagram for describing the method for manufacturing the electric connector shown in FIG. 6; and

FIG. 8 is a perspective view of an electric connector according to a third embodiment as viewed from the rear, in which some of the electric wires are omitted.

### DETAILED DESCRIPTION

### Problem to be Solved by Present Disclosure

In an electric connector disclosed in JP2017-069166A, a plurality of electric wires (conducting wires) are inserted into respective through holes. With an increase in the number of electric wires and a reduction in the diameter of the electric wire, it is becoming difficult for all the electric wires to be inserted into and fixed to the through holes provided in the housing. Thus, an electric connector in which electric wires are reliably inserted into holding holes of a housing is desired.

### Effects of Present Disclosure

According to the present disclosure, an electric connector in which electric wires are reliably inserted into holding holes of a housing and a method for manufacturing the electric connector can be provided.

### DESCRIPTION OF EMBODIMENTS OF PRESENT DISCLOSURE

First, the contents of embodiments of the present disclosure are listed and described.

(1) An electric connector according to an embodiment of the present disclosure includes a plurality of first electric wires each extending along a first direction and arranged side by side along a second direction intersecting the first direction, and a housing including a plurality of first holding holes each extending and penetrating along the first direction and arranged side by side along the second direction. A conductor of a tip portion of each of the plurality of first electric wires is housed in each of the plurality of first holding holes. The plurality of first holding holes hold the plurality of first electric wires such that the tips of the plurality of first electric wires are exposed on the front surface of the housing. The housing is provided with a first guide portion configured to, while supporting the plurality of first electric wires, introduce each of the plurality of first electric wires into each of the plurality of first holding holes toward the front surface of the housing.

In the electric connector of (1) above, the housing is provided with a first guide portion configured to, while supporting the plurality of first electric wires, introduce each of the plurality of first electric wires into each of the plurality of first holding holes. In this case, each first electric wire is inserted into the first holding hole after settled in the first guide portion, and therefore each first electric wire can be reliably inserted into the corresponding first holding hole. Thus, an electric connector in which electric wires are reliably inserted into holding holes of a housing can be obtained.

(2) In the electric connector of (1) above, the housing may be configured such that a region of the first guide portion where the plurality of first electric wires are supported is visually recognizable. In this case, when introducing the plurality of first electric wires into the plurality of first holding holes from the first guide portion, the visibility for the operator or the like is good, and therefore each electric wire can be reliably inserted into the corresponding holding hole.

(3) In the electric connector of (1) or (2) above, the first guide portion may be provided with a groove leading to each of the plurality of first holding holes. In this case, each electric wire can be inserted into each first holding hole after the electric wire is placed and settled in the groove corresponding to the first holding hole. Thus, each electric wire can be more reliably inserted into the corresponding holding hole.

(4) In the electric connector of (2) above, an end portion adjacent to the groove of each of the plurality of first holding holes may be provided with a taper. In this case, each electric wire can be more easily inserted into the first holding hole from the groove along the taper.

(5) The electric connector of any one of (1) to (4) above may further include a plurality of second electric wires each extending along the first direction and arranged side by side along the second direction. In this electric connector, the housing may further include a plurality of second holding holes each extending and penetrating along the first direction and arranged side by side along the second direction, and the plurality of second holding holes are located in a third direction with respect to the plurality of first holding holes. A conductor of a tip portion of each of the plurality of second electric wires may be housed in each of the plurality of second holding holes. The plurality of second holding holes may hold the plurality of second electric wires such that the tips of the plurality of second electric wires are exposed on the front surface of the housing. A second guide portion configured to, while supporting the plurality of second electric wires, introduce each of the plurality of second electric wires into each of the plurality of second holding holes toward the front surface of the housing may be formed in the housing. In this electric connector, the first guide portion and the second guide portion may be formed in a staircase-like shape such that the second guide portion is located farther from the front surface of the housing in the first direction than the first guide portion is. In this case, when inserting, in addition to the plurality of first electric wires, each of the plurality of second electric wires into the second holding hole, each electric wire is inserted into the second holding hole after settled in the second guide portion, and therefore each second electric wire can be reliably inserted into the corresponding second holding hole. Thus, an electric connector in which the second electric wires are reliably inserted into the second holding holes of the housing can be obtained.

(6) The electric connector of any one of (1) to (5) above may further include a plurality of third electric wires each extending along the first direction and arranged side by side along the second direction. The housing may further include a plurality of third holding holes each extending and penetrating along the first direction and arranged side by side along the second direction, and the plurality of third holding holes may be located in the third direction with respect to the plurality of first holding holes. A conductor of a tip portion of each of the plurality of third electric wires may be housed in each of the plurality of third holding holes. The plurality of third holding holes may hold the plurality of third electric wires such that the tips of the plurality of third electric wires are exposed on the front surface of the housing. A third guide portion configured to, while supporting the plurality of third electric wires, introduce each of the plurality of third electric wires into each of the plurality of third holding holes toward the front surface of the housing may be formed in the housing. In this electric connector, the third guide portion may face the opposite side to the side that the first guide portion faces. In this case, a size increase of the electric connector in the first direction due to an increase in the number of guide portions installed can be curbed. For example, in the case where eight guide portions are provided, an attempt to form the guide portions in a staircase-like shape will encounter a situation where the lengths of the eight guide portions are added along the first direction as they are, whereas the above-described configuration allows a plurality of guide portions to be separately provided on one side (for example, the upper side) and the other side (for example, the lower side) in the third direction by forming a mountainous shape as the overall shape of the guide portions, and can halve the overall length of the guide portions of the electric connector in the first direction.

(7) The electric connector of any one of (1) to (6) above may further include a first coating member coating at least portions excluding tip portions of the plurality of first electric wires, and the plurality of first electric wires may be integrated by the first coating member. In this case, the plurality of first electric wires can be easily settled in the guide portion of the housing, and each electric wire can be easily inserted into the corresponding holding hole.

(8) A method for manufacturing an electric connector according to an embodiment of the present disclosure is a method for manufacturing the electric connector of (6) above, and the method includes, introducing each of the plurality of first electric wires into the inside of each of the plurality of first holding holes from the first guide portion of the housing, inverting the housing in the third direction after the introducing of the plurality of first electric wires, and introducing each of the plurality of third electric wires into the inside of each of the plurality of third holding holes from the third guide portion of the housing after the inverting of the housing. In this case, before inserting the third electric wires, inversion is performed to improve the visibility for the operator or the like; therefore, each third electric wire can be easily inserted into the corresponding third holding hole, and furthermore the fabricated electric connector can be downsized.

### DETAILS OF EMBODIMENTS OF PRESENT DISCLOSURE

Specific examples of an electric connector and a method for manufacturing an electric connector according to the present disclosure will now be described with reference to the drawings. The present disclosure is not limited to these examples, but is indicated by the claims, and is intended to include all modifications within the meaning and scope equivalent to the claims. In the description of the drawings, the same elements are denoted by the same reference signs, and a repeated description is omitted.

### First Embodiment

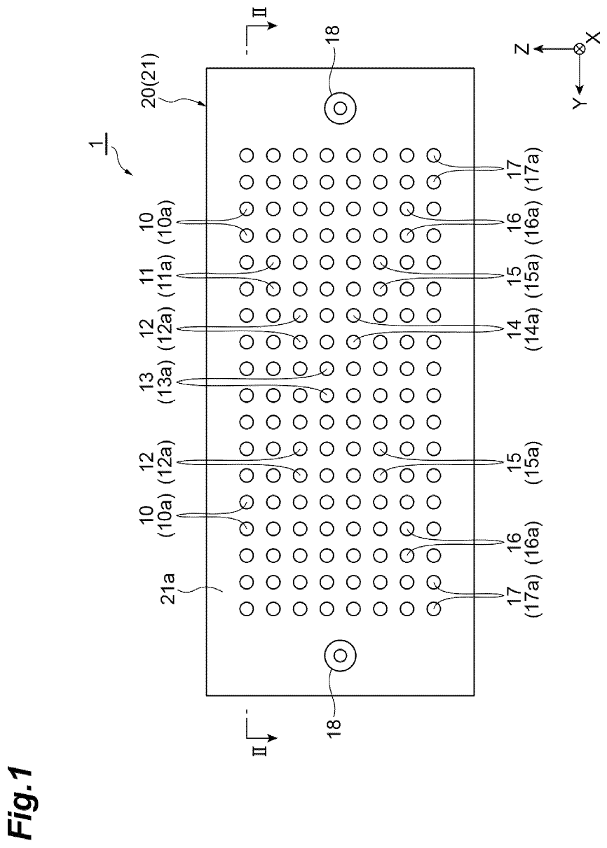

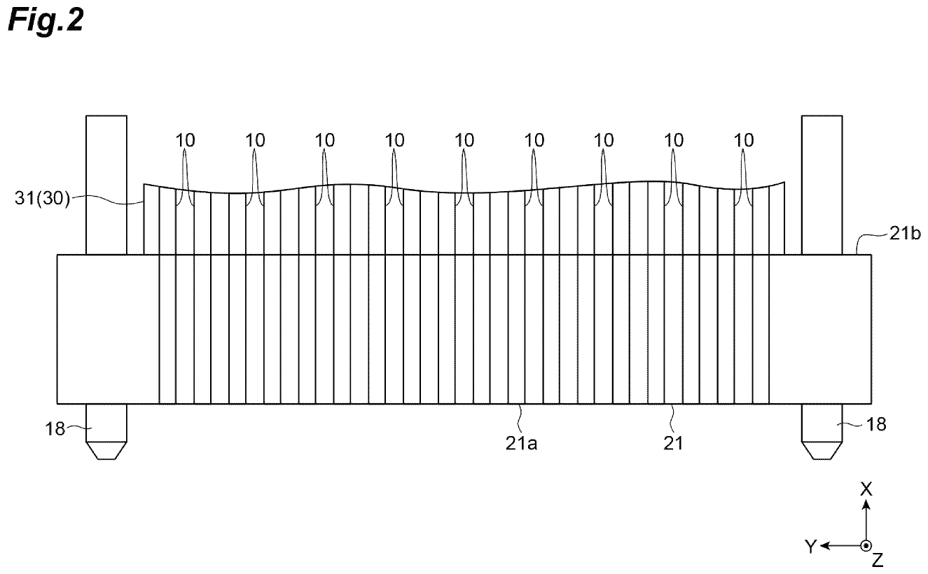

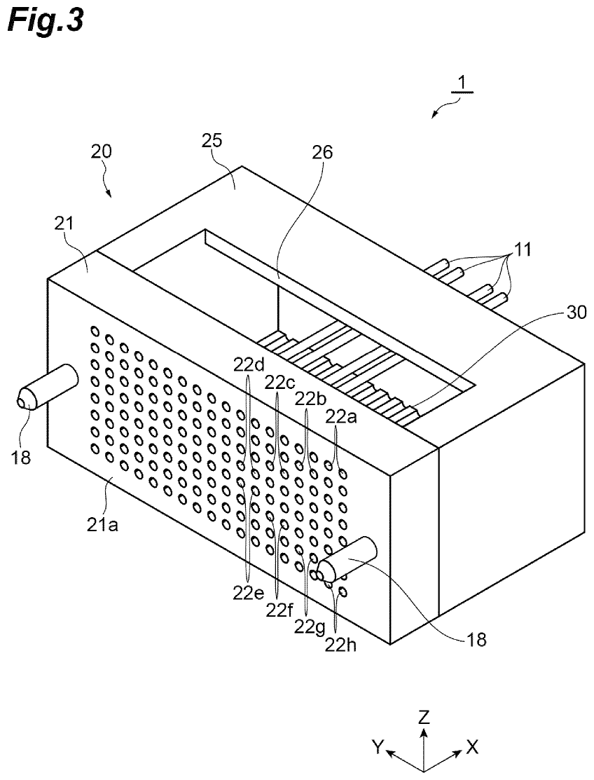

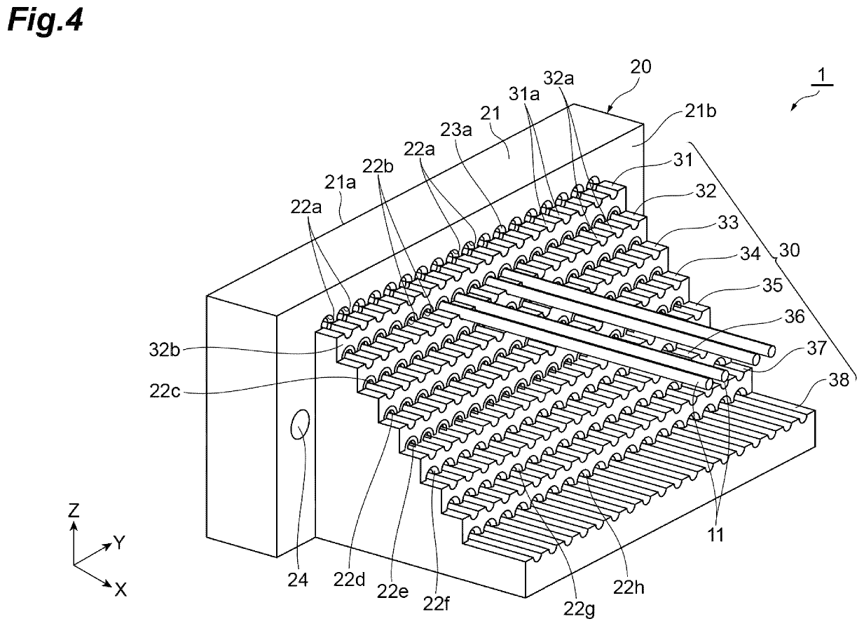

FIG. 1 is a front view of an electric connector according to a first embodiment as viewed from the front; FIG. 2 is a cross-sectional view of the electric connector shown in FIG. 1 taken along line II-II. FIG. 3 is a perspective view of the electric connector shown in FIG. 1 as viewed from the front, in which only some electric wires are shown and the other electric wires are omitted. FIG. 4 is a perspective view of the electric connector shown in FIG. 1 as viewed from the rear, in which similarly only some electric wires are shown and the other electric wires are omitted. As shown in FIGS. 1 to 4, an electric connector 1 includes a plurality of electric wires 10 (a plurality of first electric wires), a plurality of electric wires 11 (a plurality of second electric wires), a plurality of electric wires 12, a plurality of electric wires 13, a plurality of electric wires 14, a plurality of electric wires 15, a plurality of electric wires 16, and a plurality of electric wires 17 (a plurality of third electric wires) (hereinafter, also collectively referred to as “pluralities of electric wires 11 to 17”), a pair of guide pins 18 that perform positioning when connecting the electric connector 1 to the mating connector, and a housing 20 that holds the pluralities of electric wires 10 to 17. Each guide pin 18 is press-fitted into each guide hole 24 (see FIG. 4) provided in the housing 20.

The plurality of electric wires 10 are members for transmitting electric power or electric signals. As shown in FIGS. 1 and 2, the plurality of electric wires 10 each extend along an X direction, and are arranged side by side along a Y direction orthogonal to (intersecting) the X direction. Although in the present embodiment, for example, eighteen electric wires 10 are arranged side by side along the Y direction, the number of electric wires 10 is not particularly limited. Each electric wire 10 includes a conductor 10a. The conductor 10a is, for example, a metal such as copper. When the electric connector 1 is connected to the mating connector, the conductor 10a is connected to a circuit or the like of the board via a terminal provided on the mating connector. The electric wire 10 may be an insulated electric wire in which the conductor 10a is coated with an insulator, or may be a bare electric wire in which the conductor 10a is exposed as it is. The plurality of electric wires 10 may be integrated by a coating member such as a resin to form a flexible flat cable (FFC).

The conductor 10a of a tip portion of each of the plurality of electric wires 10 is housed in a holding hole 22a (see FIG. 3) provided in the housing 20 described in detail later. At this time, the tips of the electric wires 10 are exposed to the outside on the front surface 21a of the housing 20. Thereby, each of the plurality of electric wires 10 is connected to a terminal of the mating connector. The plurality of electric wires 10 may be signal lines or ground lines.

Similarly to the plurality of electric wires 10, the plurality of electric wires 11 are members for transmitting electric power or electric signals. Similarly to the plurality of electric wires 10, the plurality of electric wires 11 each extend along the X direction, and are arranged side by side along the Y direction. As shown in FIG. 1, the plurality of electric wires 11 are placed below the plurality of electric wires 10 in a Z direction. The configuration, etc. of the plurality of electric wires 11 are similar to those of the plurality of electric wires 10, and a description is omitted.

Similarly to the pluralities of electric wires 10 and 11, the pluralities of electric wires 12 to 17 are members for transmitting electric power or electric signals. Similarly to the pluralities of electric wires 10 and 11, the pluralities of electric wires 12 to 17 each extend along the X direction, and are arranged side by side along the Y direction. The pluralities of electric wires 12 to 17 are placed in order below the plurality of electric wires 11 in the Z direction. The configurations, etc. of the pluralities of electric wires 12 to 17 are similar to those of the pluralities of electric wires 10 and 11, and a description is omitted. The electric connector 1 according to the first embodiment includes such pluralities of electric wires 10 to 17, for example, includes a total of 144 electric wires of 18 wires (each set of electric wires)×8 sets. However, the number of electric wires held by the electric connector 1 is not limited thereto.

The housing 20 is a member that holds the pluralities of electric wires 10 to 17 such that the tips of the electric wires are exposed to the front (the front surface 21a) of the electric connector 1. As shown in FIGS. 3 and 4, the housing 20 has a housing front end portion 21, a housing rear end portion 25, and a stepped support portion 30. The housing 20 is formed of, for example, a precisely moldable resin such as polyphenylene sulfide (PPS) or a liquid crystal polymer (LCP). The housing front end portion 21, the housing rear end portion 25, and the stepped support portion 30 may be integrally formed, or may be attached after being formed.

The housing front end portion 21 is a portion that mainly holds the pluralities of electric wires 10 to 17, and is a plate-like member including a front surface 21a and a rear surface 21b. Each of the left edge and the right edge of the housing front end portion 21 is provided with a guide hole 24 for press-fitting the guide pin 18. The guide hole 24 penetrates the housing front end portion 21 from the front surface 21a toward the rear surface 21b.

The housing front end portion 21 and the stepped support portion 30 (details will be described later) of the housing 20 are provided with pluralities of holding holes 22a, 22b, 22c, 22d, 22e, 22f, 22g, and 22h that are through holes. The holding holes 22a to 22h are holding portions for holding the pluralities of electric wires 10 to 17, respectively. The plurality of holding holes 22a each extend and penetrate the housing front end portion 21 along the X direction, and are arranged side by side along the Y direction. The front ends of the plurality of holding holes 22a are opened on the front surface 21a of the housing front end portion 21, and the rear ends are opened on the rear surface 21b of the housing front end portion 21.

The plurality of holding holes 22b each extend and penetrate the housing front end portion 21 and the stepped support portion 30 along the X direction, and are arranged side by side along the Y direction. The plurality of holding holes 22b are placed below the plurality of holding holes 22a in the Z direction. Similarly to the plurality of holding holes 22b, the pluralities of holding holes 22c to 22h each extend and penetrate the housing front end portion 21 and the stepped support portion 30 along the X direction, and are arranged side by side along the Y direction. The pluralities of holding holes 22c to 22h are placed in order below the plurality of holding holes 22b in the Z direction. As described later, since the housing 20 has the stepped support portion 30 having a staircase-like shape, the lengths along the X direction of the pluralities of holding holes 22a to 22h are formed in ascending order. That is, the length of the plurality of holding holes 22a is the shortest, the lengths of the pluralities of holding holes 22b, 22c, 22d, 22e, 22f, and 22g form an ascending order, and the length of the plurality of holding holes 22h is the longest. The rear ends of the pluralities of holding holes 22b to 22h excluding the plurality of holding holes 22a are opened on walls of guide portions 31 to 38 of the stepped support portion 30 (for example, a wall 32b of the guide portion 32).

The conductors 10a to 17a of the tip portions of the pluralities of electric wires 10 to 17 are housed in the pluralities of holding holes 22a to 22h having the above-described configuration, respectively. More specifically, the conductor 10a of the tip portion of each of the plurality of electric wires 10 is housed in each of the plurality of holding holes 22a, the conductor 11a of the tip portion of each of the plurality of electric wires 11 is housed in each of the plurality of holding holes 22b, the conductor 12a of the tip portion of each of the plurality of electric wires 12 is housed in each of the plurality of holding holes 22c, the conductor 13a of the tip portion of each of the plurality of electric wires 13 is housed in each of the plurality of holding holes 22d, the conductor 14a of the tip portion of each of the plurality of electric wires 14 is housed in each of the plurality of holding holes 22e, the conductor 15a of the tip portion of each of the plurality of electric wires 15 is housed in each of the plurality of holding holes 22f, the conductor 16a of the tip portion of each of the plurality of electric wires 16 is housed in each of the plurality of holding holes 22g, and the conductor 17a of the tip portion of each of the plurality of electric wires 17 is housed in each of the plurality of holding holes 22h.

The front ends of the pluralities of holding holes 22a to 22h are opened on the front surface 21a of the housing 20 (the housing front end portion 21), and the pluralities of holding holes 22a to 22h hold the respective electric wires such that the tips of the pluralities of housed electric wires 10 to 17 are exposed on the front surface 21a of the housing 20.

The housing rear end portion 25 is a hollow portion surrounding the stepped support portion 30, and is formed to define a space in the inside such that the upper side of the stepped support portion 30 is opened. The housing rear end portion 25 is provided with a window portion 26 so that the operator or the like can visually recognize at least some (preferably half or more) of the guide portions 31 to 38 of the stepped support portion 30. By such a window portion 26 being provided, when the operator inserts each electric wire into the holding hole of the housing 20, the operator can easily observe the condition of the electric wire and proceed with the work.

The stepped support portion 30 is a staircase-like portion for, while supporting the pluralities of electric wires 10 to 17, introducing each of the pluralities of electric wires 10 to 17 into each of the pluralities of holding holes 22a to 22h toward the front surface 21a of the housing 20. As shown in FIG. 4, the stepped support portion 30 has guide portions 31, 32, 33, 34, 35, 36, 37, and 38. That is, the stepped support portion 30 of the electric connector 1 according to the first embodiment has eight guide portions 31 to 38. However, the number of guide portions provided in the stepped support portion 30 is not limited thereto, and it is sufficient that one or more guide portions be provided; two or more guide portions may be provided, or four or more guide portions may be provided.

The guide portion 31 is a trapezoidal portion extending in the X direction and the Y direction, and includes a plurality of grooves 31a on its upper surface. The plurality of grooves 31a each extend in the X direction, and are arranged side by side along the Y direction. Each groove 31a is continuously formed to lead to the corresponding holding hole 22a. The groove 31a is a portion that supports the electric wire 10 to be introduced into the holding hole 22a and promotes introduction, and has, for example, a semicircular cross section corresponding to the outer shape of the electric wire 10. The groove 31a may have any another shape that can support the electric wire 10, and may have, for example, a V-shaped cross section. In the guide portion 31, for example, eighteen grooves 31a are provided in order along the Y direction to correspond to eighteen electric wires 10. However, the configuration is not limited thereto. An end portion adjacent to the groove 31a of each holding hole 22a may be provided with a taper 23a of which the inner diameter narrows from the groove 31a toward the holding hole 22a.

Similarly to the guide portion 31, the guide portion 32 is a trapezoidal portion extending in the X direction and the Y direction. The guide portion 32 is located on the rear side in the X direction and on the lower side in the Z direction with respect to the guide portion 31. The guide portions 31 and 32 are in a staircase-like shape. Similarly to the guide portion 31, the guide portion 32 includes a plurality of grooves 32a on its upper surface. Similarly to the grooves 31a, the plurality of grooves 32a each extend in the X direction, and are arranged side by side along the Y direction. Each groove 32a is formed to lead to the corresponding holding hole 22b. The groove 32a is a portion that supports the electric wire 11 to be introduced into the holding hole 22b and promotes introduction, and has, for example, a semicircular cross section corresponding to the outer shape of the electric wire 11, but may have another shape. Like in the guide portion 31, an end portion adjacent to the groove 32a of each holding hole 22b may be provided with a taper 23b of which the inner diameter narrows from the groove 32a toward the holding hole 22b. The length along the X direction of the guide portion 32 may be the same as, longer than, or shorter than that of the guide portion 31.

Similarly to the guide portions 31 and 32, each of the guide portions 33 to 38 is a trapezoidal portion extending in the X direction and the Y direction. Each of the guide portions 33 to 38 is located on the rear side in the X direction and on the lower side in the Z direction with respect to the guide portion 32, and a staircase-like shape is formed from the guide portion 31 toward the guide portion 38. Like in the guide portions 31 and 32, a plurality of grooves are formed on the upper surface of each of the guide portions 33 to 38. Each of these grooves continuously leads to the corresponding one of the holding holes 22c to 22h, and is similar to each of the grooves 31a and 32a in the guide portions 31 and 32 in that, when inserting the electric wire into the holding hole, it supports the electric wire and promotes introduction. Other configurations and functions of the guide portions 33 to 38 are similar to those of the guide portions 31 and 32.

The stepped support portion 30 including such guide portions 31 to 38 exhibits a staircase-like shape when viewed from the side. However, in the electric connector 1, all the guide portions 31 to 38 of the stepped support portion 30 are located in the housing rear end portion 25.

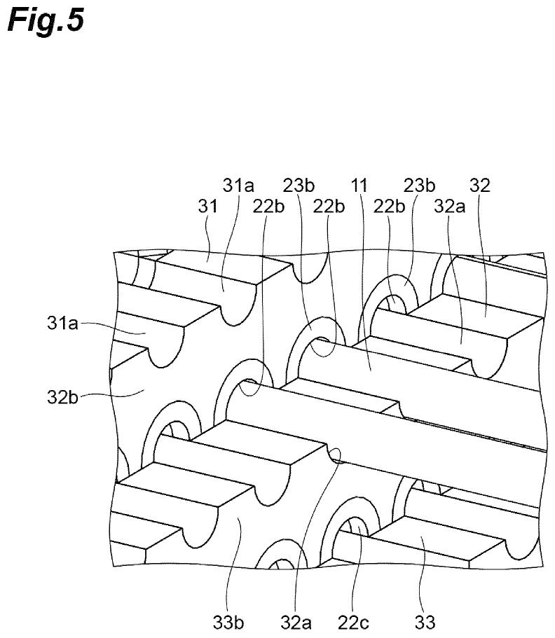

Here, a method for inserting the electric wire 11 into the holding hole 22b will now be described with reference to FIGS. 3 to 5. In this method, first, a tip portion of the electric wire 11 is inserted into the housing 20 from an opening 27 on the rear side of the housing rear end portion 25 of the housing 20. Then, the tip portion of the electric wire 11 is placed and supported in the groove 32a of the guide portion 32 of the stepped support portion 30. Here, the direction, etc. of the tip portion of the electric wire 11 are settled. In the case where the plurality of electric wires 11 are a flexible flat cable, the tip portions of the plurality of electric wires 11 are substantially simultaneously placed, supported, and settled in the corresponding grooves 32a.

Subsequently, the electric wire 11 of which the direction, etc. of the tip are settled in the groove 32a is moved forward along the groove 32a, and is further aligned by the taper 23b. After that, when the electric wire 11 is further moved forward, the electric wire 11 is smoothly inserted into the holding hole 22b from the taper 23b. The electric wire 11 is moved forward until its tip is exposed on the front surface 21a of the housing 20, and is then fixed to the housing 20 (the holding hole 22b or the like) by a predetermined method (for example, an adhesive or the like). Similarly, the other pluralities of electric wires 10, and 12 to 17 are inserted into and fixed to the holding holes while being supported with the corresponding grooves. Thus, an electric connector 1 holding pluralities of electric wires 10 to 17 can be obtained.

As above, in the electric connector 1 according to the present embodiment, the housing 20 is provided with guide portions 31 to 38 configured to, while supporting the electric wires 10 to 17, introduce the electric wires 10 to 17 into the holding holes 22a to 22h, respectively. Since the electric wires 10 to 17 are inserted into the corresponding holding holes 22a to 22h after settled in such guide portions 31 to 38, the electric wires 10 to 17 can be reliably inserted into the corresponding holding holes 22a to 22h. Thus, an electric connector in which electric wires are reliably inserted into holding holes of a housing can be obtained.

In the electric connector 1 according to the present embodiment, the housing 20 is configured such that regions of the guide portions 31 to 38 where the pluralities of electric wires 10 to 17 are supported are visually recognizable. Thus, when introducing the pluralities of electric wires 10 to 17 into the holding holes 22a to 22h from the guide portions 31 to 38, the visibility for the operator or the like is good, and therefore each electric wire can be more reliably inserted into the corresponding holding hole.

In the electric connector 1 according to the present embodiment, the guide portions 31 to 38 are provided with grooves leading to the holding holes 22a to 22h, respectively. Thus, the electric wires 10 to 17 can be inserted into the holding holes 22a to 22h after the electric wires 10 to 17 are placed and settled in the grooves corresponding to the holding holes 22a to 22h. Thus, each electric wire can be more reliably inserted into the corresponding holding hole.

In the electric connector 1 according to the present embodiment, an end portion adjacent to the groove of each of the holding holes 22a to 22h may be provided with a taper. In this case, each electric wire can be more easily inserted into the first holding hole from the groove along the taper.

In the electric connector 1 according to the present embodiment, the guide portions 31 to 38 are formed in a staircase-like shape such that a guide portion adjacent on the rear side is located farther from the front surface 21a of the housing 20 in the X direction than each of the guide portions 31 to 38 is. Thus, for example, when inserting the pluralities of electric wires 10 to 17 into the corresponding holding holes, the electric wires 10 to 17 are inserted into the holding holes after settled in the guide portions 31 to 38, and therefore each electric wire can be reliably inserted into the corresponding holding hole. Thus, an electric connector in which electric wires are reliably inserted into holding holes of a housing can be obtained.

In the electric connector 1 according to the present embodiment, portions excluding tip portions of each set of electric wires 10 to 17, may be coated with a coating member, and an integrated flexible flat cable may be used as each set of the pluralities of electric wires 10 to 17. In this case, the pluralities of electric wires 10 to 17 can be easily settled in the guide portions 31 to 38 of the housing 20, and the electric wires 10 to 17 can be easily inserted into the corresponding holding holes 22a to 22h.

### Second Embodiment

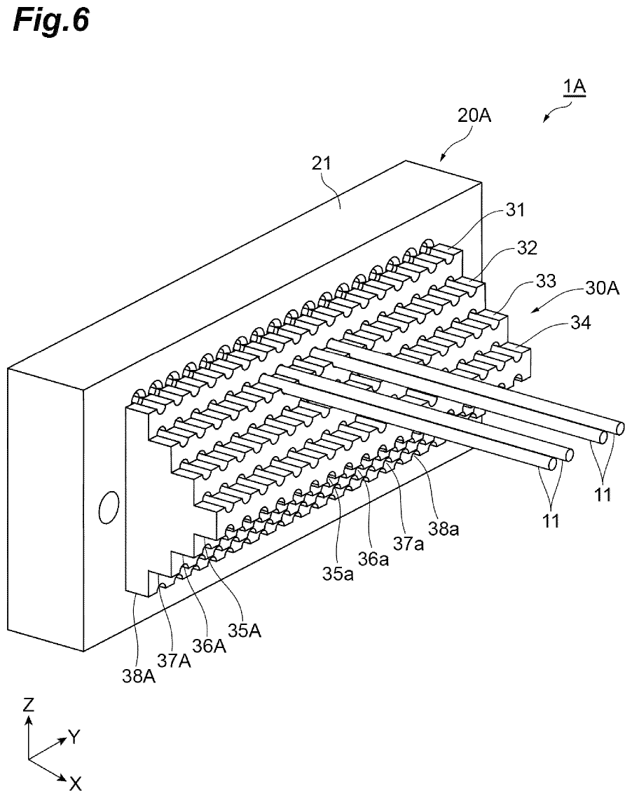

Next, an electric connector 1A according to a second embodiment is described with reference to FIG. 6. Similarly to the electric connector 1 according to the first embodiment, the electric connector 1A includes pluralities of electric wires 10 to 17, a pair of guide pins 18, and a housing 20A that holds the pluralities of electric wires 10 to 17. As shown in FIG. 6, in the electric connector 1A, the shape of a stepped support portion 30A is different from that of the stepped support portion 30 according to the first embodiment. In the following, differences from the first embodiment are mainly described, and a description of other configurations is omitted.

The stepped support portion 30A has guide portions 35A, 36A, 37A, and 38A in addition to the guide portions 31 to 34. The guide portions 35A to 38A have a shape in which the guide portions 31 to 34 are vertically inverted in the Z direction. That is, like in the guide portions 31 to 34, grooves 35a to 38a leading to the corresponding holding holes 22e to 22h are formed in the guide portions 35A to 38A. The present embodiment is similar to the first embodiment in that the grooves 35a to 38a extend in the X direction and are arranged side by side along the Y direction. However, the present embodiment is different in that the guide portions 35A to 38A face downward in the Z direction. The stepped support portion 30A according to the second embodiment exhibits a mountainous shape when viewed from the side, and is different from the stepped support portion 30 having a staircase-like shape as a whole. Thus, the holding holes 22e to 22h are formed to be shorter than in the first embodiment, and correspond to the lengths of the holding holes 22d to 22a, respectively. For example, the holding hole 22h is opened on the rear surface 21b of the housing front end portion 21.

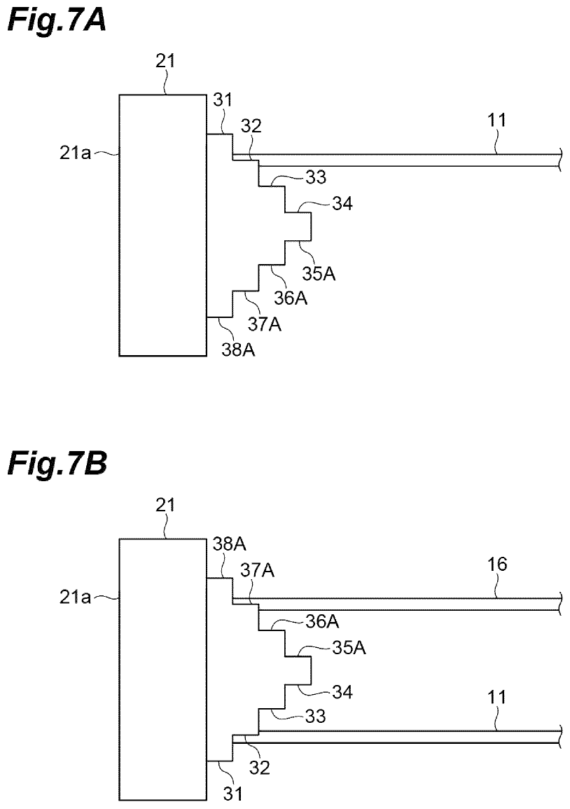

Here, a method for manufacturing the electric connector 1A according to the second embodiment will now be described with reference to FIGS. 7A and 7B. Since the electric connector 1A has a configuration in which the stepped support portion 30A has a mountainous shape when viewed from the side, first, as shown in FIG. 7A, the electric wires 10 to 13 are supported in the guide portions 31 to 34 on the upper side, and are inserted into the corresponding holding holes 22a to 22d. In FIG. 7A, only the electric wire 11 is shown for ease of description. Thereby, the tips of the electric wires 10 to 13 are exposed on the front surface 21a of the housing 20.

Subsequently, when the insertion of the electric wires 10 to 13 is ended, as shown in FIG. 7B, the housing 20 is inverted in the Z direction so that the guide portions 35A to 38A of the stepped support portion 30A are oriented (face) upward. Then, in this state, the electric wires 14 to 17 are supported in the guide portions 35A to 38A, and are inserted into the corresponding holding holes 22a to 22d. In FIG. 7B, only the electric wire 16 is shown for ease of description. Thereby, the tips of the electric wires 14 to 17 are exposed on the front surface 21a of the housing 20. Thus, the electric connector 1A is formed.

As above, in the electric connector 1A according to the present embodiment, like in the first embodiment, the housing 20A is provided with guide portions 31 to 34 and 35A to 38A configured to, while supporting the electric wires 10 to 17, introduce the electric wires 10 to 17 into the holding holes 22a to 22h, respectively. Since the electric wires 10 to 17 are inserted into the corresponding holding holes 22a to 22h after settled in such guide portions 31 to 34 and 35A to 38A, the electric wires 10 to 17 can be reliably inserted into the corresponding holding holes 22a to 22h. Thus, an electric connector in which electric wires are reliably inserted into holding holes of a housing can be obtained. Similar operation and effect to the first embodiment can be exhibited also for other respects.

In the electric connector 1A according to the present embodiment, the guide portions 35A to 38A face the opposite side to the side that the guide portions 31 to 34 face (are oriented to). Thus, a size increase of the electric connector in the X direction due to an increase in the number of guide portions installed can be curbed. For example, in the case where eight guide portions are provided, an attempt to form the whole in a staircase-like shape as in the first embodiment will encounter a situation where the lengths of the eight guide portions 31 to 38 are added along the X direction as they are, whereas the configuration of the second embodiment allows a plurality of guide portions to be separately provided on one side (for example, the upper side) and the other side (for example, the lower side) in the Z direction by forming a mountainous shape as the overall shape of the guide portions 31 to 34 and 35A to 38A, and can halve the overall length of the guide portions of the electric connector in the X direction. That is, the electric connector can be downsized.

In the method for manufacturing the electric connector 1A according to the present embodiment, the visibility for the operator or the like can be improved by inverting the housing 20A, etc. before inserting the electric wires 14 to 17. Thus, the electric wires 14 to 17 can be easily inserted into the corresponding holding holes 22e to 22h, and furthermore the fabricated electric connector 1A can be downsized.

### Third Embodiment

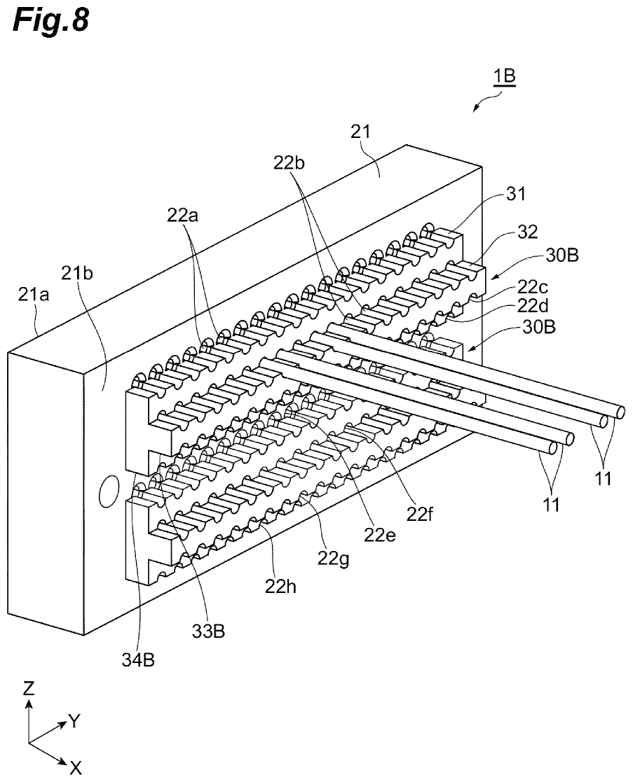

Next, an electric connector 1B according to a third embodiment is described with reference to FIG. 8. Similarly to the electric connectors 1 and 1A according to the first and second embodiments, the electric connector 1B includes pluralities of electric wires 10 to 17, a pair of guide pins 18, and a housing 20B that holds the pluralities of electric wires 10 to 17. As shown in FIG. 8, in the electric connector 1B, the shape of two stepped support portions 30B is different from that of the stepped support portion 30 according to the first embodiment. In the following, differences from the first embodiment are mainly described, and a description of other configurations is omitted.

Each stepped support portion 30B has guide portions 33B and 34B in addition to the guide portions 31 and 32. The guide portions 33B and 34B have a shape in which the guide portions 31 and 32 are vertically inverted in the Z direction. That is, like in the guide portions 31 and 32, grooves leading to the corresponding holding holes 22c and 22d are formed in the guide portions 33B and 34B. The configuration is similar to the first embodiment in that these grooves extend in the X direction and are arranged side by side along the Y direction. However, the configuration is different in that the guide portions 33B and 34B face downward in the Z direction. Like in the second embodiment, each stepped support portion 30B according to the third embodiment exhibits a mountainous shape when viewed from the side. However, in the third embodiment, since two stepped support portions 30B are provided, the length in the X direction is still shorter than that of the electric connector 1A in the second embodiment. The stepped support portion 30B located on the lower side corresponds to the guide portions 35 to 38 and 35A to 38A in the stepped support portions 30 and 30A. Otherwise, the configuration, and operation and effect of this embodiment are similar to those of the first embodiment and the second embodiment.

Hereinabove, embodiments of the present disclosure are described in detail; however, the present disclosure is not limited to the above embodiments, and can be applied to various embodiments.

What is claimed is:

1. An electric connector comprising:
a plurality of first electric wires each extending along a first direction and arranged side by side along a second direction intersecting the first direction; and
a housing including a plurality of first holding holes each extending and penetrating along the first direction and arranged side by side along the second direction,
wherein a conductor of a tip portion of each of the plurality of first electric wires is housed in each of the plurality of first holding holes,
the plurality of first holding holes hold the plurality of first electric wires such that tips of the plurality of first electric wires are exposed on a front surface of the housing, and
the housing is provided with a first guide portion configured to, while supporting the plurality of first electric wires, introduce each of the plurality of first electric wires into each of the plurality of first holding holes toward the front surface of the housing.

2. The electric connector according to claim 1, wherein the housing is configured such that a region of the first guide portion where the plurality of first electric wires are supported is visually recognizable.

3. The electric connector according to claim 1, wherein the first guide portion is provided with a groove leading to each of the plurality of first holding holes.

4. The electric connector according to claim 3, wherein an end portion adjacent to the groove of each of the plurality of first holding holes is provided with a taper.

5. The electric connector according to claim 1, further comprising
a plurality of second electric wires each extending along the first direction and arranged side by side along the second direction,
wherein the housing further includes a plurality of second holding holes each extending and penetrating along the first direction and arranged side by side along the second direction, and the plurality of second holding holes are located in a third direction intersecting the first direction and the second direction with respect to the plurality of first holding holes,
a conductor of a tip portion of each of the plurality of second electric wires is housed in each of the plurality of second holding holes,
the plurality of second holding holes hold the plurality of second electric wires such that tips of the plurality of second electric wires are exposed on the front surface of the housing,
a second guide portion configured to, while supporting the plurality of second electric wires, introduce each of the plurality of second electric wires into each of the plurality of second holding holes toward the front surface of the housing is formed in the housing, and
the first guide portion and the second guide portion are formed in a staircase-like shape such that the second guide portion is located farther from the front surface of the housing in the first direction than the first guide portion is.

6. The electric connector according to claim 1, further comprising
a plurality of third electric wires each extending along the first direction and arranged side by side along the second direction,
wherein the housing further includes a plurality of third holding holes each extending and penetrating along the first direction and arranged side by side along the second direction, and the plurality of third holding holes are located in a third direction intersecting the first direction and the second direction with respect to the plurality of first holding holes,
a conductor of a tip portion of each of the plurality of third electric wires is housed in each of the plurality of third holding holes,
the plurality of third holding holes hold the plurality of third electric wires such that tips of the plurality of third electric wires are exposed on the front surface of the housing,
a third guide portion configured to, while supporting the plurality of third electric wires, introduce each of the plurality of third electric wires into each of the plurality of third holding holes toward the front surface of the housing is formed in the housing, and
the third guide portion faces an opposite side to a side that the first guide portion faces.

7. The electric connector according to claim 1, further comprising
a first coating member coating at least portions excluding tip portions of the plurality of first electric wires, wherein the plurality of first electric wires are integrated by the first coating member.

8. A method for manufacturing the electric connector according to claim 6, the method comprising:
introducing each of the plurality of first electric wires into an inside of each of the plurality of first holding holes from the first guide portion of the housing;
inverting the housing in the third direction after the introducing of the plurality of first electric wires; and
introducing each of the plurality of third electric wires into an inside of each of the plurality of third holding holes from the third guide portion of the housing after the inverting of the housing.
